(19) United States
(12) Patent Application Publication
(10) Pub. No.: US 2025/0209516 A1
(43) Pub. Date: Jun. 26, 2025

(54) GENERATING PERSONALIZED CONTENT CAROUSELS AND ITEMS USING MACHINE-LEARNING LARGE LANGUAGE MODELS AND EMBEDDINGS

(71) Applicant: Maplebear Inc., San Francisco, CA (US)

(72) Inventors: Prithvishankar Srinivasan, Seattle, WA (US); Min Xie, Santa Clara, CA (US); Shishir Kumar Prasad, San Ramon, CA (US); Shih-Ting Lin, Santa Clara, CA (US); Saurav Manchanda, Seattle, WA (US); Riddhima Sejpal, Dublin, CA (US)

(21) Appl. No.: 18/990,154

(22) Filed: Dec. 20, 2024

Related U.S. Application Data
(60) Provisional application No. 63/614,439, filed on Dec. 22, 2023.
(60) Provisional application No. 63/614,446, filed on Dec. 22, 2023.

(51) Int. Cl. G06Q 30/0601; G06Q 30/0251

(52) U.S. Cl. CPC G06Q 30/0631; G06Q 30/0269; G06Q 30/0643

(57) ABSTRACT

An online system generates personalized content carousels and personalized content items in conjunction with large language models (LLMs). The personalized carousels and items are generated subject to consent from users. In one or more embodiments, a content item is a recipe page, coupon, incentive, advertisement, sponsored page, or sponsored item, accessed via the online system. The online system generates one or more carousel themes for the user based on the order history of the user by prompting the LLM. For each carousel theme, the online system also generates a set of content item names. The online system applies an embedding model to identify content items that are relevant to each content name. One or more content carousels including the set of content items are presented to the user.

### CROSS-REFERENCE TO RELATED APPLICATIONS

This application claims the benefit of U.S. Provisional Patent Application No. 63/614,446, filed on Dec. 22, 2023, and U.S. Provisional Patent Application No. 63/614,439, filed on Dec. 22, 2023, all of which are hereby incorporated by reference in their entirety.

### BACKGROUND

Content item recommendations are important entry points for online applications for increasing user engagement and satisfaction. In many systems, content carousels are created manually. For example, for an upcoming holiday such as Thanksgiving, the items within the carousel may be manually created and/or curated to match the Thanksgiving theme. Furthermore, an online system may provide various types of content items (e.g., recipe pages) to a user, but in some instances, the content item might not reflect the user's preferences and may include, for example, ingredients that the user cannot consume due to dietary restrictions.

### SUMMARY

In accordance with one or more aspects of the disclosure, the online system deduces the theme of content carousels based on customer behavior. The online system may access a profile associated with a user and which includes user data. The online system may generate a first prompt for a machine learning model based on the user data. The first prompt for the machine learning model requests one or more carousel themes each associated with a set of content items. The online system may provide the first prompt to the machine learning model. The online system may receive as output, from the machine learning model, one or more carousel themes. The online system may generate one or more second prompts for a machine learning model based on the one or more carousel themes. For each carousel theme, a respective second prompt for the machine learning model requests a set of content names for the set of content items associated with the potential theme. The online system may provide the one or more second prompts to the machine learning model. The online system may receive as output, from the machine learning model, the set of content names associated with each carousel theme. The online system may, for each carousel theme, provide, to an embeddings model, the carousel theme and the set of content names for the carousel theme to generate embeddings for the set of content names. The online system may identify the set of content items associated with the carousel theme by comparing the embeddings for the content names with embeddings for the set of content items. Each content item within the set of content items includes content item data from a content database.

In accordance with one or more aspects of the disclosure, an online system may access a profile associated with a user. The profile includes user preferences and user history. The online system may generate a first prompt for the machine learning model. The first prompt for the machine learning model requests a set of user preferences based on the profile associated with the user and a list of potential cuisines. The online system may provide a prompt to the machine learning model. The online system may receive as output, from the machine learning model, the set of user preferences. The online system may store the received set of user preferences in a user preference table associated with the user. The online system may receive, from the user, a selection of a recipe from a recipe database. The online system may generate a set of filters for the user based on the set of user preferences from the user preference table. The online system may receive, from the user, a selection of one filter from the set of filters. The online system may generate a prompt for a machine learning model based on the selected content item and the selected filter. The prompt for the machine learning model requests an adaptation to the selected content item based on the selected filter. The online system may provide the second prompt to the machine learning model. The online system may receive as output, from the machine learning model, an adapted content item based on the selected content item and the selected filter. The online system may provide to the user the adapted content item. The online system may present to the user via a user interface (UI), the set of content items for the one or more carousel themes as content carousels.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for deducing the theme of content carousels based on customer behavior, in accordance with one or more embodiments.

FIG. 4 illustrates an example of identifying the set of content items associated with the carousel theme, in accordance with one or more embodiments.

FIG. 5 illustrates an example display of a carousel theme for an online system, in accordance with one or more embodiments.

FIG. 6 is a flowchart for deducing the theme of content carousels based on customer behavior, in accordance with one or more embodiments.

FIG. 7 is a flowchart for generating an adaptation of the selected content item, in accordance with one or more embodiments.

### DETAILED DESCRIPTION

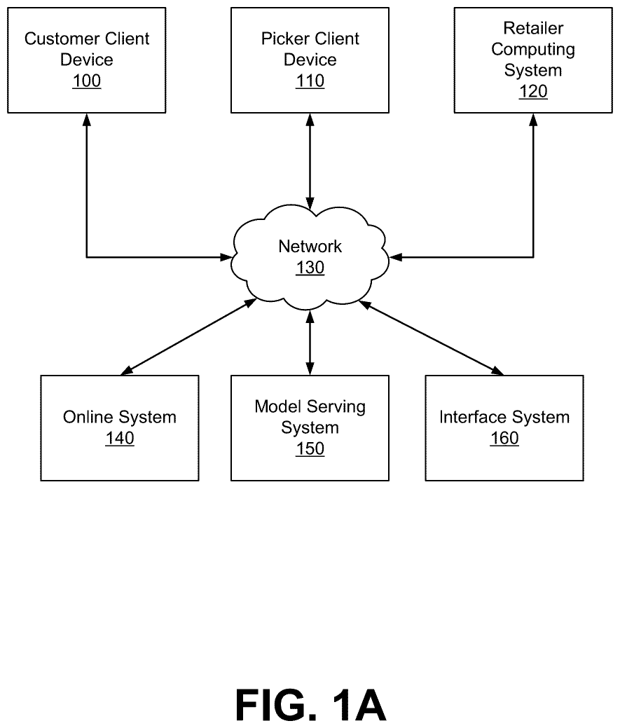

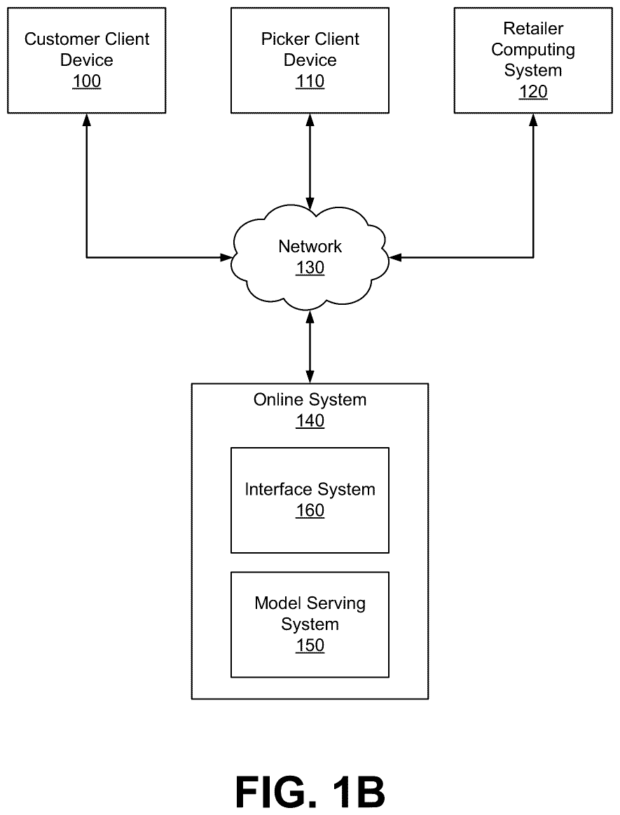

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

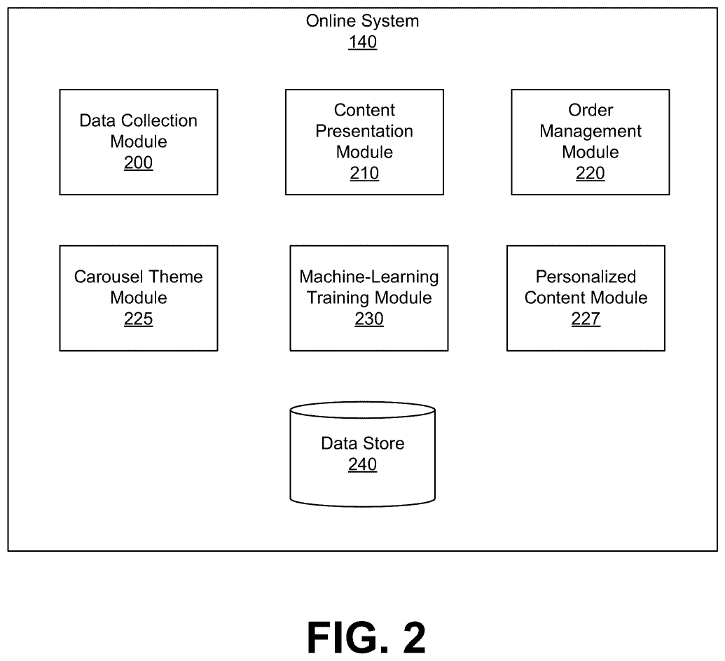

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

The online system 140 described herein generates personalized content carousels and personalized content items in conjunction with LLMs. In one or more embodiments, the personalized carousels and items are generated subject to consent from users. In one or more embodiments, a content item is a recipe page, coupon, incentive, advertisement, sponsored page, sponsored item, accessed via the online system 140. For purposes of illustration, the content items are recipe pages, and the content carousels are carousels of recipe pages. However, it is appreciated that in other embodiments, the content items and carousels can be configured in any appropriate manner. For example, the carousels can also be carousels of items.

In one or more embodiments, the online system 140 determines a theme for a content carousel and embeds relevant content based on that theme. Specifically, the online system 140 prepares a prompt for input to the model serving system 150. The online system 140 receives a response to the prompt from the model serving system 150 based on execution of the machine-learned model using the prompt. The online system 140 obtains the first response, which includes content carousel themes. In some embodiments, the online system 140 prepares a second prompt for input to the model serving system 150 and receives a second response to the prompt which includes names of content items to be included in the carousel based on the carousel themes. The online system 140 identifies content associated with the carousel theme by comparing the embeddings for the content names with embeddings for the set of content items which includes content data from a content database. The online system presents to the user via a user interface (UI), the set of content items for the one or more carousel themes as content carousels.

In one or more embodiments, the online system 140 personalizes and generates content variations based on user history. Specifically, the online system 140 prepares a first prompt for input to the model serving system 150, requesting a set of user preferences based on the profile associated with the user and a list of potential cuisines. The online system 140 receives a response to the prompt from the model serving system 150 based on execution of the machine-learned model using the prompt. The online system 140 obtains the response which includes the set of user preferences. The online system 140 stores the received set of user preferences in a user preference table associated with the user. The online system 140 may receive, from the user, a selection of content from a content database. The online system 140 generates a set of filters for the user based on the set of user preferences from the user preference table and receives, from the user, a selection of one filter from the set of filters. The online system 140 prepares a second prompt for input to the model serving system 150 based on the selected content and the selected filter requesting an adaptation to the selected content based on the selected filter. The online system 140 receives a response to the prompt from the model serving system 150 based on execution of the machine-learned model using the prompt. The online system 140 obtains the response which includes an adapted content based on the selected content and the selected filter.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a carousel theme module 225, a machine learning training module 230, a personalized content module 227, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

### I. Generating a Personalized Carousel Theme

The carousel theme module 225 determines the theme of the content carousel based on user behavior as well as embeds content items from the content database in the content carousel for presentation to the user. The carousel theme module 225 accesses a profile associated with a user, which includes user data. User data includes user order history and other information associated with the user's account, such as favorites, bookmarked or other saved content, etc. Subject to receiving user consent, the carousel theme module 225 generates a first prompt for a machine learning model based on the user data. The first prompt for the machine learning model requests one or more carousel themes each associated with a set of content. For example, a prompt may include “For a content recommendation system, list some holiday or seasonal events for recommending content carousels.” As another example, a prompt may include “Based on a user's history who buys the following products Chicken Breast, eggs, milk, protein bars, granola, mixed nuts, avocados create 5 themes for content recommendations.” The prompt may include information associated with the user profile so that the results may be based on the user data.

The carousel theme module 225 provides the first prompt to the machine learning model. The carousel theme module 225 may receive as output, from the machine learning model, one or more carousel themes. For an example, output may include a list of holidays, seasonal events or significant cultural events which may be a theme for a content carousel. As a further example, themes may include categories such as “Healthy Protein-Packed Meals,” “Quick and Nutritious Breakfasts,” “High-Protein Snacks,” “Lean and Mean Chicken Contents,” and “Heart-Healthy Meals.” The output may be in the form of a list of themes and may include categories of themes. For example, there may be a list with a category of holiday themes and another category of seasonal events such that the holiday themes include Christmas and July 4^{th} and the season events include harvest season and beach weekends.

The carousel theme module 225 generates one or more second prompts for a machine learning model based on the one or more carousel themes. For each carousel theme, a respective second prompt for the machine learning model requests a set of content names for the set of content items associated with the potential theme. The second prompt may include at least one or the full set of potential carousel themes received as output from the first prompt. For example, a second prompt for a content item of a recipe may include “give recipe names for a theme of heart-healthy meals”.

The carousel theme module 225 provides the one or more second prompts to the LLM. The carousel theme module 225 receives as output, from the machine learning model, the set of content item names associated with each carousel theme. For example, content item names for recipes provided in response to the prompt “give recipe names for heart-healthy meals” may include the recipe names “Avocado and Grilled Chicken Salad,” “Nutty Avocado Spread on Wholegrain Toast.” The output may be in the form of a list of recipe names.

The carousel theme module 225, for each carousel theme, provides, to an embeddings model, the carousel theme and the set of content item names for the carousel theme to generate embeddings for the set of content item names. For each content item name, the embeddings model generates a unique embedding (numerical representation) in a high-dimensional space. These embeddings reflect the inherent features and relationships between the content names-so that the content names may be compared and identified.

The carousel theme module 225 identifies the set of content items associated with the carousel theme by comparing the embeddings for the content names with embeddings for the set of content items. Each content item within the set of content items includes content data from a content database. For example, when a content item is a recipe page, the recipe page may include the name of the recipe, ingredients for the recipe, instructions for making the item in the recipe, and/or descriptions or summary of the recipe.

Specifically, for each content item name obtained from LLM, the carousel theme module 225 obtains embeddings for the set of content items. An embedding for a content item may be generated by, for example, applying a machine-learning embedding model to the name of the content item, the description of the content item, and the like. The latent space for the content item embeddings may be the same as the latent space for the content name embeddings and may have a same dimensionality. For a content name, the carousel theme module 225 selects one or more content items with the closest embedding. This efficiently pairs content names with associated content items that are stored and maintained by the online system 140 based on their embeddings.

The carousel theme module 225 presents to the user via a user interface (UI), the set of content items for the one or more carousel themes as content carousels. The content carousels may include links to pages detailing each content, pictures of each item associated with the content item, and a label for the theme of the carousel. This way, the carousel theme module 225 generates personalized content carousels that are synthesized with themes and content items that are relevant to users. Rather than presenting static carousels, users can receive and interact with more relevant content carousels.

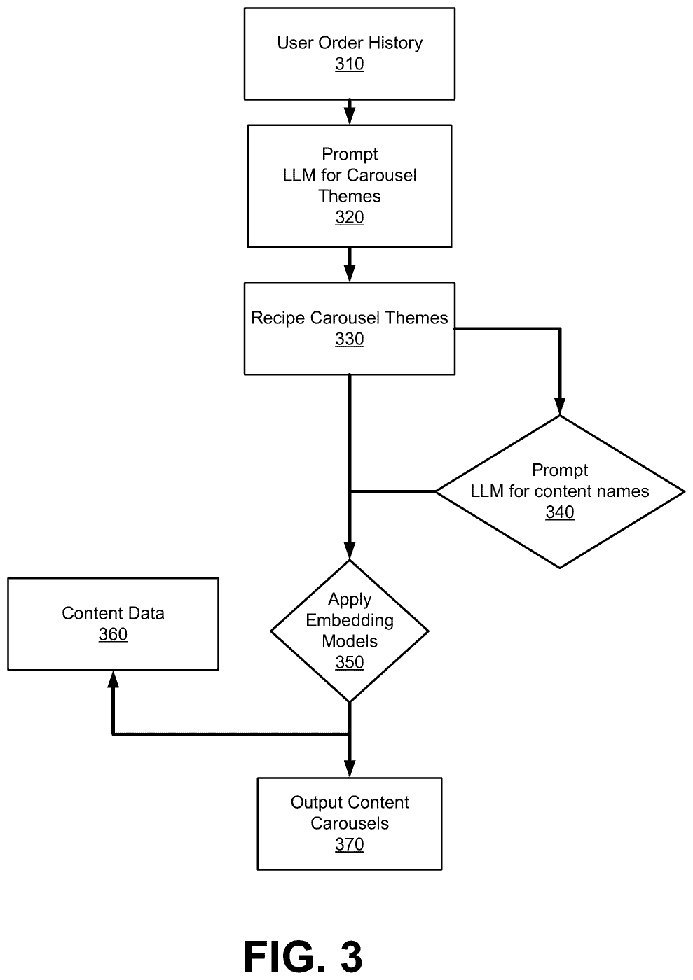

FIG. 3 is a flowchart for a method of generating themed content carousels based on user behavior, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The carousel theme module 225 accesses user order history 310 and other information associated with the user's account, such as favorites, bookmarked or saved contents, etc. User order history 310 includes a digital record of a user's transactions conducted on the platform. Information may include details such as items purchased, order dates, payment methods implemented, shipment tracking information, and any returns or cancellations processed.

The carousel theme module 225 generates a first prompt for the machine learning model 320 based on the user order history 310. The first prompt for the carousel themes machine learning model 320 requests one or more carousel themes each associated with a set of content items. For example, a prompt may include “For a content recommendation system, list some holiday or seasonal events for recommending content carousels.” As another example, a prompt may include “Based on a user's history who buys the following products Chicken Breast, eggs, milk, protein bars, granola, mixed nuts, avocados create 5 themes for content recommendations.” The prompt may include information associated with the user profile so that the results may be based on the user data.

The carousel theme module 225 provides the first prompt to the carousel themes machine learning model 320. The carousel theme module 225 may receive as output, from the carousel themes machine learning model 320, one or more carousel themes 330. For example, carousel themes 330 may include a list of holidays, seasonal events or significant cultural events which may be a theme for a content carousel. As further example, carousel themes 330 may include categories such as “Healthy Protein-Packed Meals,” “Quick and Nutritious Breakfasts,” “High-Protein Snacks,” “Lean and Mean Chicken Contents,” and “Heart-Healthy Meals.” The carousel themes 330 may be in the form of a list of themes and may include categories of themes. For example, there may be a list with a category of holiday themes and another category of seasonal events such that the holiday themes include Christmas and July 4th and the seasonal events include harvest season and beach weekends.

The carousel theme module 225 generates one or more second prompts for a machine-learning model 340 based on the one or more carousel themes 330. For each carousel theme 330, a respective second prompt for the machine-learning model 340 requests a set of content item names for the set of content items associated with the potential theme. The second prompt may include at least one or the full set of potential carousel themes received as output from the first prompt. For example, a prompt may include “give content names for heart-healthy meals”.

The carousel theme module 225 provides the one or more second prompts to the content named machine-learning model 340. The carousel theme module 225 receives as output, from the machine-learning model 340, the set of content names associated with each carousel theme 330. For example, content names provided in response to the prompt “give content names for heart-healthy meals” may include the content names “Avocado and Grilled Chicken Salad; Nutty Avocado Spread on Wholegrain Toast”. The output may be in the form of a list of content names.

The carousel theme module 225, for each carousel theme 330, provides, to an embeddings model 350, the carousel theme and/or the set of content names for the carousel theme to generate embeddings for the set of content names. For each content name, the embeddings model 350 generates a unique embedding (numerical representation) in a high-dimensional space. These embeddings reflect the inherent features and relationships between the content names—so that the content names may be compared and identified.

The carousel theme module 225 identifies the set of content items associated with the carousel theme 330 by comparing the embeddings for the content names with embeddings for the set of content items. Each content item within the set of content items includes content data from a content database 360. In one or more embodiments, for each content name, the content item with the most similar embedding is identified as the corresponding content. This efficiently pairs content names with their associated content items based on their embeddings.

The carousel theme module 225 presents to the user via a user interface, the set of content items for the one or more carousel themes as content carousels 370. The content carousels may include links to pages detailing each content, pictures of each item associated with the content, and a label for the theme of the carousel. In some embodiments, the carousel theme module 225 receives, via the user interface, user feedback related to recipes, links, and content carousel themes, and user feedback is included in training data examples.

In one or more embodiments, the carousel theme module 225 obtains feedback from users after presenting personalized content carousels to users. In one or more instances, the carousel theme module 225 records positive instances where after a particular user is presented with a content carousel, the user clicks or otherwise interacts with items in the carousel, converts on items in the carousel, and the like. These instances indicate that the personalized content carousels were constructed effectively, and the user had a high-degree of engagement. The carousel theme module 225 may also record negative instances where after a particular user is presented with a content carousel, the user does not actually engage with content items in the content carousel, indicating the user did not have a high engagement with the carousel.

The carousel theme module 225 may also use these instances to fine-tune parameters of the LLM. In one instance, the carousel theme module 225 retrieves the prompt and response pairs of positive instances, where the prompt includes the request for personalized themes based on user order history and the response includes themes for the respective user. The carousel theme module 225 constructs a training dataset including these training examples. The parameters of the LLM are applied to the prompts to generate estimated outputs. A loss function is computed that indicates a difference between the estimated outputs and the responses. The parameters of the LLM are updated based on backpropagating one or more terms from the loss function.

In one instance, the carousel theme module 225 retrieves the prompt and response pairs of positive instances, where the prompt includes the request for the set of content item names based on the generated theme and the response includes the set of content item names for the respective user. The carousel theme module 225 constructs a training dataset including these training examples. The parameters of the LLM are applied to the prompts to generate the estimated outputs. A loss function is computed that indicates a difference between the estimated outputs and the responses. The parameters of the LLM are updated based on backpropagating one or more terms from the loss function.

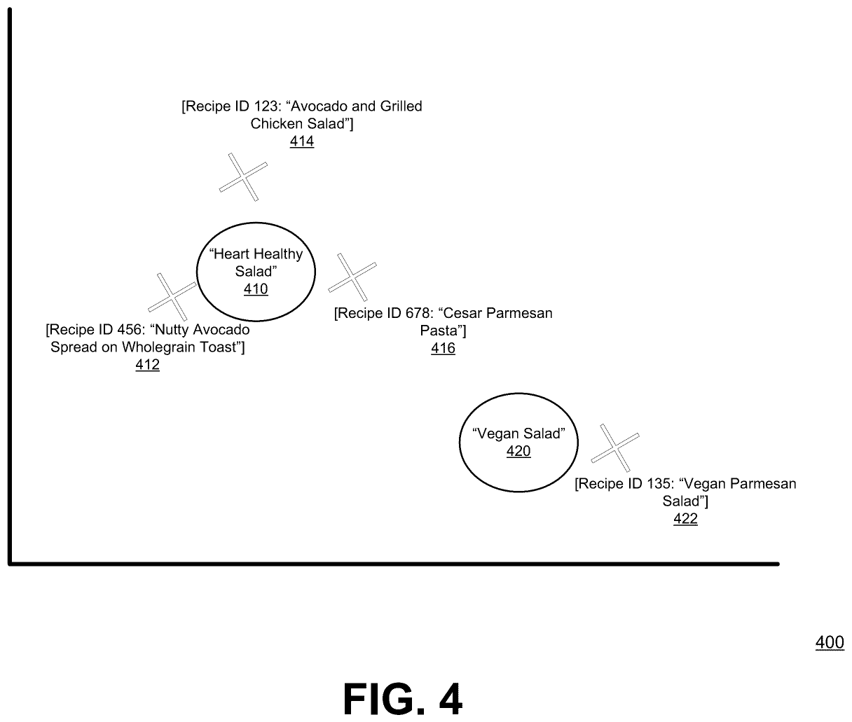

FIG. 4 illustrates an example of identifying the set of content items associated with the carousel theme and the set of content names for the carousel theme, in accordance with one or more embodiments. As an example, the carousel theme module 225 identifies the set of content items associated with the carousel theme of “Heart Healthy Meals” with a content name of “Heart Healthy Salad” 410. The carousel theme module 225 applies an embedding model to the determined set of content names associated with the carousel theme. The carousel theme module 225 compares the embeddings for the content names with embeddings for the set of content items. For the content name of “Heart Healthy Salad” 410, the carousel theme module 225 identifies a set of content items such as Recipe ID 456 “Nutty Avocado Spread on Wholegrain Toast” 412, and Recipe ID 678: “Cesar Parmesan Pasta” 416 from a content database 360. For each content name, the content item with the most similar embedding is identified as the corresponding content. This efficiently pairs content names with their associated content items based on their embeddings. As an example, the Recipe ID 123 “Avocado and Grilled Chicken Salad” 414 is mapped to the carousel theme of “Heart Healthy Salad” 410.

### II. Generating a Personalized Content Item

The personalized content module 227 accesses a profile associated with a user after receiving consent from the user. The profile includes user preferences and user history. The user preferences may include preferred vendors, preferred shopping categories, and general frequency of orders. The user account maintains a history of the user's previous order details, otherwise known as historical order data. Historical order data may include the order description, order date and time, the vendor information, the monetary value of the order, and specific item details, including the quantity and characteristics of the item(s) ordered.

The personalized content module 227 may generate a first prompt for the machine-learning model (e.g., LLM). The first prompt for the machine-learning model requests a set of user preferences based on the profile associated with the user and a list of potential cuisines or attributes (e.g., diets). The first prompt may include the accessed user preferences and history, a set of the possible cuisines or attributes to pick from, and instructions regarding formatting of the output. In one or more embodiments, the formatted output may be in JSON format. The list of potential cuisines or attributes may match the cuisine categories identified by the online system's catalog.

For example, the first prompt may include “Based on a user's history who buys the following products: sweet potato, yams, eggs, milk, protein bars, granola, mixed nuts, avocados, pick top three cuisines and diets from the following list to suggest to the user. Cuisine list: African, Asian, East Asian, South Asian, Afghan, Indian, Pakistani, Southeast Asian, Caribbean, European, British, English, French, Italian, Scandinavian, Jewish, Mediterranean, Middle Eastern, North American, American, Central American, Southern U.S., Texas, Pacific, South American, Algerian, Chinese, Japanese, Korean, Filipino.; Diet list: Vegetarian, Gluten-Free, Kosher, Vegan, Contains Alcohol, Ketogenic, Organic, Halal.”

The personalized content module 227 provides the first prompt to the machine-learning model. The personalized content module 227 may receive as output, from the machine-learning model, the set of user preferences. The output may include descriptions and reasoning for certain choices as well as how each choice fits the user history and previously stated preferences. For example, the output from the LLM may include (in JSON or other structured data format):

“cuisines”: [
{“name”: “American”, “description”: “Many of these ingredients are staples in Southern U.S. cuisine. Yams and sweet potatoes are used often, and eggs, milk, and nuts can be found in a variety of dishes.”},
{“name”: “Mediterranean”, “description”: “This cuisine involves a diverse use of vegetables, nuts, and dairy products. Avocados and eggs are also consumed frequently in this cuisine.”},
{“name”: “Asian”, “description”: “Eggs are an essential part of Japanese meals, and sweet potatoes could be used in traditional dishes. The inclusion of mixed nuts could be adapted into a variety of Asian dishes as well.”}],

“diets”: [
{“name”: “Vegetarian”, “description”: “Given the list of products, none of them contain meat or fish, aligning well with a vegetarian diet.”},
{“name”: “Gluten-Free”, “description”: “None of these items contain gluten, making a gluten-free diet possible with these ingredients.”},
{“name”: “Organic”, “description”: “If the items purchased are organic, this diet would be an ideal suggestion. It's also generally health-conscious, aligning with the profile developed from the user's purchase history.”}]}”.

The personalized content module 227 stores the received set of user preferences in a user preference table associated with the user. The personalized content module 227 may store in a table each of the suggested cuisines or attributes from the first output as well as the provided description highlighting the reasons behind each choice. In some embodiments, the output is formatted in JSON format and can be parsed into the table format accordingly because the output follows a structured syntax.

The personalized content module 227 may receive, from the user, a selection of a content from a content database. Specifically, the personalized content module 227 may provide, via the user interface, a set of content items in a themed carousel to suggest to the user, for the user to select a content from the suggested set of content items in the theme carousel. The personalized content module 227 may provide the suggested set of content items from the content database based on the theme of the content carousel. The personalized content module 227 may provide, to the user, a user interface for the online system 140, which enables users to conveniently access and select a content item from an extensive content database. In various embodiments, the user interface may employ graphical, textual, or voice-activated elements, providing the user with multiple means of searching and selecting a preferred content.

The user may peruse the content items based on categories, cuisines, ingredients, or nutritional preferences, among other factors. Contents, as stored in the content database, may include a variety of cuisines, cooking techniques, dietary restrictions, and ingredient combinations. The content database may be organized based on cuisine type, cooking method, primary ingredients, and special dietary considerations as well as other factors. Each content item in the database may also include information such as ingredients, cook time, difficulty level, nutritional information, and meal type. Each of the content items are presented via a user interface to the user as part of a listing of contents, such as via a carousel of snapshots and thumbnails of contents, or in a list of content names. The content items may be presented with pictures and other details. The user selects one of the listed content items in order to access the full content page which outlines the full content item and any other related information.

The personalized content module 227 may generate a set of filters for the user based on the set of user preferences from the user preference table. Each filter indicates an option for a way that the user may customize the content item, and may correspond to the cuisines and/or attributes extracted and stored in the user preference table for a user. For example, filters may include vegetarian, kosher, high protein, etc. The personalized content module 227 generates a set of filters for the user based on the user preferences stored in the user preference table. The personalized content module 227 processes the data within the user preference table, generating a tailored set of filters that align closely with the user's preferences. These filters may encompass varying aspects, such as preferred categories, vendors, item types, price ranges, or nutritional preferences. This set of filters is provided to the user, for user selection, via the user interface. The personalized content module 227 may receive, from the user, a selection of one filter from the set of filters.

The personalized content module 227 may generate a second prompt for a second machine-learning model (e.g., LLM) based on the selected content item and filter. The second prompt for the machine-learning model requests an adaptation to the selected content item based on the selected filter. The second prompt may include the details and steps of the selected content, user preferences such as organic or gluten-free, and products associated with the user's history. The second prompt may also include instructions regarding the formatting of the output. For example, the second prompt may include:
“For the given content item “Zesty Shrimp tacos with Salsa” steps below: 1 Preheat the oven to 375° F. 2 Toss the shrimp with olive oil, chili powder, cumin, smoked paprika, salt, and black pepper in a bowl. 3 Arrange the shrimp on a baking sheet and bake for 8-10 minutes, until cooked through. 4 Meanwhile, prepare the salsa. In a large mixing bowl, stir together the black beans, red onion, red bell pepper, avocado, and jalapeno. 5 Drizzle with lime juice and olive oil, then sprinkle with salt and black pepper. Toss well to combine. 6 Serve the cooked shrimp on warm tortillas, topped with the salsa and garnished with cilantro and lime wedges. Ingredients: Lime wedges ½ red onion, diced 1 red bell pepper, diced 1 jalapeno, diced ¼ cup fresh lime juice 2 tbsp. olive oil 1 avocado, diced 1 lb. raw shrimp, peeled and deveined 1 tbsp. olive oil 1 tbsp. chili powder ¼ tsp. salt ¼ tsp. black pepper ½ tsp. smoked paprika ¼ tsp. black pepper 1 tsp. cumin 6-8 corn tortillas Cilantro, chopped 1 can black beans, rinsed and drained ¼ tsp. salt Make a variation of this content for a user who has “Vegetarian”, “Gluten-Free” and “Organic” preferences making substitutions in ingredients with regularly available grocery products. Try to implement these items from the user's history if possible: Sweet potato, yams, eggs, milk, protein bars, granola, mixed nuts, avocados. Give response in compressed JSON format.”

The personalized content module 227 may provide the second prompt to the machine-learning model. The personalized content module 227 may receive as output, from the second machine learning model, an adapted content based on the selected content and the selected filter. For example, the output may include
“contentName”: “Zesty Sweet Potato & Yam Tacos with Avocado Salsa”,
“dietType”: [“Vegetarian”, “Gluten-Free”, “Organic”],
“steps”: [“Preheat the oven to 375° F.”, “Toss the sweet potato and yams with olive oil, chili powder, cumin, smoked paprika, salt, and black pepper in a bowl.”, “Arrange the sweet potato and yams on a baking sheet and bake for 20-30 minutes, until cooked through.”, “Meanwhile, prepare the salsa. In a large mixing bowl, stir together the black beans, red onion, red bell pepper, avocado, and jalapeno.”, “Drizzle with lime juice and olive oil, then sprinkle with salt and black pepper. Toss well to combine.”, “Blend some mixed nuts into a fine powder, add to salsa for additional flavor.”, “Serve the cooked sweet potato and yams on warm corn tortillas, topped with the salsa and garnished with cilantro and lime wedges.”],
“ingredients”: {“1 Sweet Potato”: “diced”, “1 Yam”: “diced”, “Avocado”: “diced”, “Red Onion”: “diced”, “Red Bell Pepper”: “diced”, “Jalapeno”: “diced”, “¼ cup fresh Lime Juice”: “”, “2 tbsp. Olive Oil”: “”, “1 tbsp. Chili Powder”: “”, “¼ tsp. Salt”: “”, “½ tsp. Smoked Paprika”: “”, “1 tsp. Cumin”: “”, “6-8 Corn Tortillas”: “”, “1 can Black Beans”: “rinsed and drained”, “¼ cup mixed Nuts”: “blended”, “Cilantro”: “chopped”, “Lime Wedges”: “”}}”

The personalized content module 227 may provide, to the user, the adapted content. The adapted content item is provided to match the selected filter. The user interface may organize the adapted content such as a recipe into distinct sections, such as ingredients, preparation steps, and nutritional information, among others. Interactive features may be incorporated, including options to further modify the content, save the adapted version to a personal collection, or share it with others. This way, the online system 140 can create and synthesize personalized content items based on one or more selected user preferences that are relevant to the user.

### III. Generating a Personalized Content Item for a Personalized Content Theme

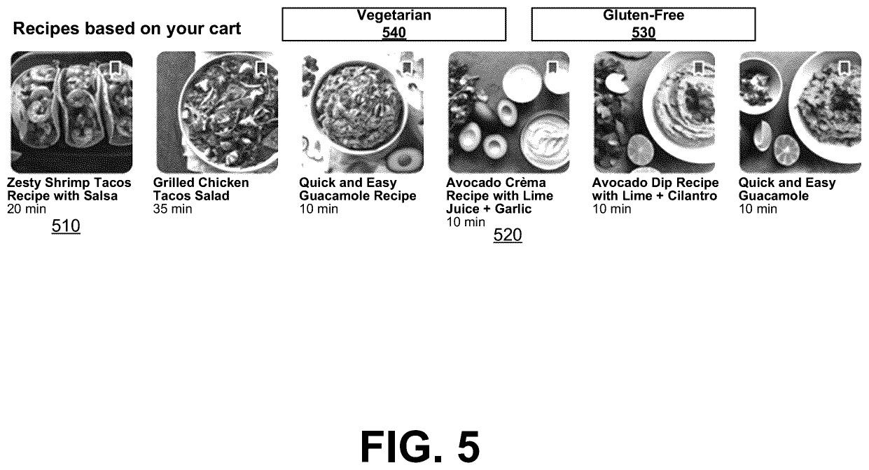

In one or more embodiments, returning to the method of generating content carousels as described in Section I above, after the personalized content carousels are generated and presented to the user, the online system 140 may perform steps to personalize the content items, as described in Section II. For example, after a content carousel has been generated, the online system 140 may obtain filters for the user and may present UI elements indicating the obtained filters for display on the client device, as further described in conjunction with FIG. 5. The online system 140 may present a set of filters based on the received set of user preferences. The user may be prompted to select a given recipe and/or to apply a filter. In one or more embodiments, the online system 140 may obtain a personalized version of the selected content item according to that described in Section II.

As an example, for the generated carousel theme of “Heart-healthy meals”, the online system 140 identifies and obtains a set of recipes (e.g., “Avocado and Grilled Chicken Salad,” “Nutty Avocado Spread on Wholegrain Toast”). The user may select the “Avocado and Grilled Chicken Salad” recipe. The online system 140 may present a set of filters based on the received set of user preferences (e.g., Vegetarian), wherein a user selects the Vegetarian filter. The online system 140 presents a personalized recipe for a vegetarian adaptation of a selected recipe of Avocado and Grilled Chicken Salad (e.g., Avocado and Grilled Tofu Salad).

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

FIG. 5 illustrates an example display of a carousel theme for an online system 140, in accordance with one or more embodiments. FIG. 5 illustrates a carousel of recipe thumbnails as displayed on a user interface (e.g., Zesty Shrimp Tacos Recipe with Salsa 510, and Avocado Crema Recipe with Lime Juice and Garlic 520). Each thumbnail includes a picture, the title of the recipe, as well as a time expectation for the recipe. The thumbnails have an icon to save or bookmark the recipe for review later. The carousel as a whole is titled and given a brief description as to the theme and reasoning behind the creation of that specific carousel. Additionally, FIG. 5 illustrates an example display of a UI element for a set of filters (e.g., Vegetarian 540 and Gluten-Free 530) a user may apply to personalize the content recipe thumbnails. As an example, a user may apply a filter to the selected recipe item Zesty Shrimp Tacos Recipe with Salsa 510 to generate a personalized Gluten-Free 530 adaptation.

### Flowchart Illustrating Methods of Generating Personalized Content Carousels and Content Items

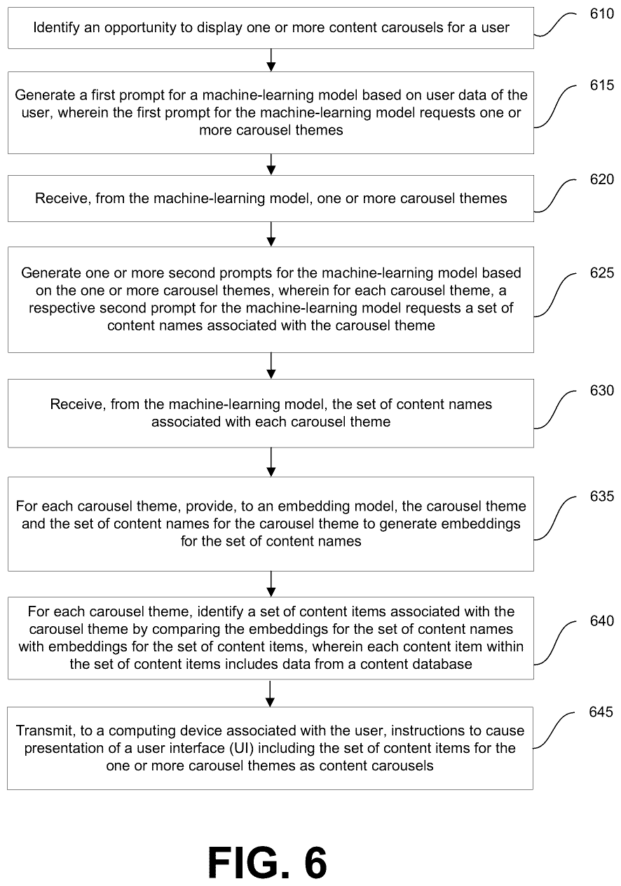

FIG. 6 is a flowchart for deducing the theme of content carousels based on customer behavior, in accordance with one or more embodiments. The content carousel module 225 identifies 610 an opportunity to display one or more content carousels for a user. The content carousel module 225 generates 615 a first prompt for a machine-learning model based on user data of the user, wherein the first prompt for the machine-learning model requests one or more carousel themes. The content carousel module 225 receives 620, from the machine-learning model, one or more carousel themes. The content carousel module 225 generates 625 one or more second prompts for the machine-learning model based on the one or more carousel themes, wherein for each carousel theme, a respective second prompt for the machine-learning model requests a set of content names associated with the carousel theme. The content carousel module 225 receives 630, from the machine-learning model, the set of content names associated with each carousel theme. The content carousel module 225, for each carousel theme, provides 635, to an embedding model, the carousel theme and the set of content names for the carousel theme to generate embeddings for the set of content names. The content carousel module 225, for each carousel theme, identifies 640 a set of content items associated with the carousel theme by comparing the embeddings for the set of content names with embeddings for the set of content items, wherein each content item within the set of content items includes data from a content database. The content carousel module 225 transmits 645, to a computing device associated with the user, instructions to cause presentation of a user interface (UI) including the set of content items for the one or more carousel themes as content carousels.

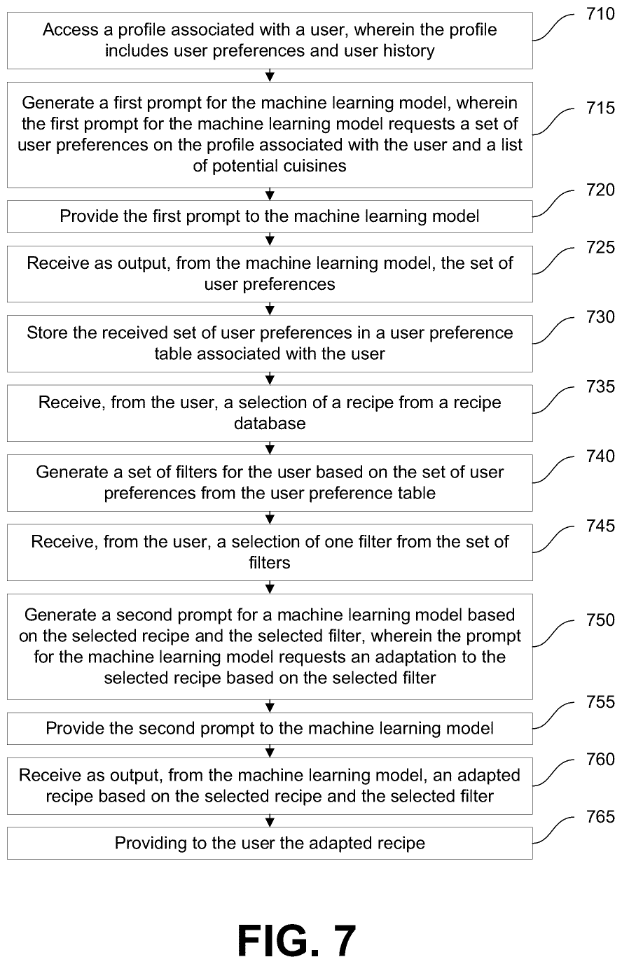

FIG. 7 is a flowchart for generating an adaptation of the selected content item, in accordance with one or more embodiments. The personalized content module 227 accesses 710 a profile associated with a user. The profile includes user preferences and user history. The personalized content module 227 generates 715 a first prompt for the machine learning model. The first prompt for the machine learning model requests a set of user preferences based on the profile associated with the user and a list of potential cuisines. The personalized content module 227 provides 720 the first prompt to the machine learning model. The personalized content module 227 receives 725 as output, from the machine learning model, the set of user preferences. The personalized content module 227 stores 730 the received set of user preferences in a user preference table associated with the user. The personalized content module 227 receives 735, from the user, a selection of a recipe from a recipe database. The personalized content module 227 generates 740 a set of filters for the user based on the set of user preferences from the user preference table. The personalized content module 227 receives 745, from the user, a selection of one filter from the set of filters. The personalized content module 227 generates 750 a second prompt for a machine learning model based on the selected recipe and the selected filter, wherein the second prompt for the machine learning model requests an adaptation to the selected recipe based on the selected filter. The personalized content module 227 provides 755 the second prompt to the machine learning model. The personalized content module 227 receives 760 as output from the machine learning model, an adapted recipe based on the selected recipe and the selected filter. The personalized content module 227 provides 765, to the user's device, the adapted recipe. In some embodiments, the personalized content module 227 receives and collects feedback from the user via the user's device regarding whether the adapted recipe has met the user's needs.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
identifying an opportunity to display one or more content carousels for a user;
generating a first prompt for a machine-learning model based on user data of the user, wherein the first prompt for the machine-learning model requests one or more carousel themes;
receiving, from the machine-learning model, the one or more carousel themes;
generating one or more second prompts for the machine-learning model based on the one or more carousel themes, wherein for each carousel theme, a respective second prompt for the machine-learning model requests a set of content names associated with the carousel theme;
receiving, from the machine-learning model, the set of content names associated with each carousel theme;
for each carousel theme, providing, to an embedding model, the carousel theme or the set of content names for the carousel theme to generate embeddings for the set of content names;
for each carousel theme, identifying a set of content items associated with the carousel theme by comparing the embeddings for the set of content names with embeddings for the set of content items; and
transmitting, to a computing device associated with the user, instructions to cause presentation of a user interface (UI) including the set of content items for the one or more carousel themes as content carousels.

2. The method of claim 1, wherein the machine-learning model is trained by:
constructing a training example including a training prompt including user data for a second user and at least one carousel theme for the second user;
applying parameters of the machine-learning model to the training prompt to generate estimated outputs;
computing a loss function indicating a difference between the estimated outputs and the at least one carousel theme; and
backpropagating one or more terms from the loss function to update the parameters.

3. The method of claim 1, wherein identifying the set of content items associated with the carousel theme further comprises:
generating distances between an embedding for a content name and embeddings for a subset of content items; and
retrieving the subset of content items from a database responsive to identifying that the distances are within a determined threshold.

4. The method of claim 1, wherein identifying a content item in the set of content items comprises identifying: a recipe page, a coupon, an incentive, an advertisement, a sponsored page, or a sponsored item.

5. The method of claim 1, further comprising:
obtaining feedback from the user after presentation of the content carousels, the feedback indicating whether the user interacted with the set of content items;
constructing a training example including the first prompt and the one or more carousel themes;
applying parameters of the machine-learning model to the first prompt to generate estimated outputs;
computing a loss function indicating a difference between the estimated outputs and the one or more carousel themes; and
updating the parameters of the machine-learning model to backpropagate terms from the loss function.

6. The method of claim 1, further comprising:
obtaining feedback from the user after presentation of the content carousels, the feedback indicating whether the user interacted with the set of content items;
constructing a training example including the one or more second prompts and the set of content names for at least one carousel theme;
applying parameters of the machine-learning model to the one or more second prompts to generate estimated outputs;
computing a loss function indicating a difference between the estimated outputs and the set of content names for the at least one carousel theme; and
updating the parameters of the machine-learning model to backpropagate terms from the loss function.

7. The method of claim 1, further comprising:
receiving, from the user, a selection of a content item from a content database;
generating a set of filters for the user based on a set of user preferences associated with the user;
receiving, from the user, a selection of a filter from the set of filters;
generating a third prompt for the machine-learning model based on the selected content item and the selected filter, wherein the third prompt for the machine-learning model requests an adaptation to the selected content item based on the selected filter;
receiving, from the machine-learning model, an adapted content item based on the selected content item and the selected filter; and
transmitting, to a computing device associated with the user, instructions to cause presentation of a user interface (UI) including the adapted content item based on the selected content item and the selected filter.

8. The method of claim 7, further comprising:
obtaining a set of user preferences for the user, wherein the set of user preferences are one or a combination of cuisines, diets, or attributes for the user, wherein the set of filters are generated from the set of user preferences.

9. The method of claim 7, further comprising:
storing the set of user preferences in a user preference table associated with the user, wherein the user preference table includes a description of a reason for the user preferences for the user.

10. A non-transitory computer-readable storage medium storing computer instructions, wherein the computer instructions, when executed by one or more processors, cause the one or more processors to perform operations comprising:
identifying an opportunity to display one or more content carousels for a user;
generating a first prompt for a machine-learning model based on user data of the user, wherein the first prompt for the machine-learning model requests one or more carousel themes;
receiving, from the machine-learning model, the one or more carousel themes;
generating one or more second prompts for the machine-learning model based on the one or more carousel themes, wherein for each carousel theme, a respective second prompt for the machine-learning model requests a set of content names associated with the carousel theme;
receiving, from the machine-learning model, the set of content names associated with each carousel theme;
for each carousel theme, providing, to an embedding model, the carousel theme or the set of content names for the carousel theme to generate embeddings for the set of content names;
for each carousel theme, identifying a set of content items associated with the carousel theme by comparing the embeddings for the set of content names with embeddings for the set of content items; and
transmitting, to a computing device associated with the user, instructions to cause presentation of a user interface (UI) including the set of content items for the one or more carousel themes as content carousels.

11. The non-transitory computer-readable storage medium of claim 10, wherein the machine-learning model is trained by:
constructing a training example including a training prompt including user data for a second user and at least one carousel theme for the second user;
applying parameters of the machine-learning model to the training prompt to generate estimated outputs;
computing a loss function indicating a difference between the estimated outputs and the at least one carousel theme; and
backpropagating one or more terms from the loss function to update the parameters.

12. The non-transitory computer-readable storage medium of claim 10, wherein identifying the set of content items associated with the carousel theme further comprises:
generating distances between an embedding for a content name and embeddings for a subset of content items; and
retrieving the subset of content items from a database responsive to identifying that the distances are within a determined threshold.

13. The non-transitory computer-readable storage medium of claim 10, wherein identifying a content item in the set of content items comprises identifying a recipe page, a coupon, an incentive, an advertisement, a sponsored page, or a sponsored item.

14. The non-transitory computer-readable storage medium of claim 10, the operations further comprising:
obtaining feedback from the user after presentation of the content carousels, the feedback indicating whether the user interacted with the set of content items;
constructing a training example including the first prompt and the one or more carousel themes;
applying parameters of the machine-learning model to the first prompt to generate estimated outputs;
computing a loss function indicating a difference between the estimated outputs and the one or more carousel themes; and
updating the parameters of the machine-learning model to backpropagate terms from the loss function.

15. The non-transitory computer-readable storage medium of claim 10, the operations further comprising:
obtaining feedback from the user after presentation of the content carousels, the feedback indicating whether the user interacted with the set of content items;
constructing a training example including the one or more second prompts and the set of content names for at least one carousel theme;
applying parameters of the machine-learning model to the one or more second prompts to generate estimated outputs;
computing a loss function indicating a difference between the estimated outputs and the set of content names for the at least one carousel theme; and
updating the parameters of the machine-learning model to backpropagate terms from the loss function.

16. The non-transitory computer-readable storage medium of claim 10, the operations further comprising:
receiving, from the user, a selection of a content item from a content database;
generating a set of filters for the user based on a set of user preferences associated with the user;
receiving, from the user, a selection of a filter from the set of filters;
generating a third prompt for the machine-learning model based on the selected content item and the selected filter, wherein the third prompt for the machine-learning model requests an adaptation to the selected content item based on the selected filter;
receiving, from the machine-learning model, an adapted content item based on the selected content item and the selected filter; and
transmitting, to a computing device associated with the user, instructions to cause presentation of a user interface (UI) including the adapted content item based on the selected content item and the selected filter.

17. A system comprising:
a processor; and
a non-transitory computer-readable storage medium storing computer instructions, wherein the computer instructions, when executed by one or more processors, cause the one or more processors to perform operations comprising:
identifying an opportunity to display one or more content carousels for a user;
generating a first prompt for a machine-learning model based on user data of the user, wherein the first prompt for the machine-learning model requests one or more carousel themes;
receiving, from the machine-learning model, the one or more carousel themes;
generating one or more second prompts for the machine-learning model based on the one or more carousel themes, wherein for each carousel theme, a respective second prompt for the machine-learning model requests a set of content names associated with the carousel theme;
receiving, from the machine-learning model, the set of content names associated with each carousel theme;
for each carousel theme, providing, to an embedding model, the carousel theme or the set of content names for the carousel theme to generate embeddings for the set of content names;
for each carousel theme, identifying a set of content items associated with the carousel theme by comparing the embeddings for the set of content names with embeddings for the set of content items; and
transmitting, to a computing device associated with the user, instructions to cause presentation of a user interface (UI) including the set of content items for the one or more carousel themes as content carousels.

18. The system of claim 17, wherein identifying the set of content items associated with the carousel theme further comprises:
generating distances between an embedding for a content name and embeddings for a subset of content items; and
retrieving the subset of content items from a database responsive to identifying that the distances are within a determined threshold.

19. The system of claim 17, wherein a content item in the set of content items is a recipe page, coupon, incentive, advertisement, sponsored page, or a sponsored item.

20. The system of claim 17, the operations further comprising:
obtaining feedback from the user after presentation of the content carousels, the feedback indicating whether the user interacted with the set of content items;
constructing a training example including the first prompt and the one or more carousel themes;
applying parameters of the machine-learning model to the first prompt to generate estimated outputs;
computing a loss function indicating a difference between the estimated outputs and the one or more carousel themes; and
updating the parameters of the machine-learning model to backpropagate terms from the loss function.
